(19) United States
(12) Patent Application Publication
(10) Pub. No.: US 2026/0087295 A1
(43) Pub. Date: Mar. 26, 2026

(54) BIOLOGICALLY INERT AND SECURE FOOD TAGGANT

(71) Applicant: P-CHIP IP Holdings Inc., Chicago, IL (US)

(72) Inventors: William E. EIBON, Chicago, IL (US); Massimo BAIO, Chicago, IL (US); Aditya L. GOTTUMUKKALA, Chicago, IL (US)

(73) Assignee: P-CHIP IP Holdings Inc., Chicago, IL (US)

(21) Appl. No.: 19/109,978

(22) PCT Filed: Sep. 8, 2023
(86) PCT No.: PCT/US2023/073797

§ 371 Date: Mar. 7, 2025

Related U.S. Application Data
(60) Provisional application No. 63/375,150, filed on Sep. 9, 2022.

(51) Int. Cl. G06K 19/07; B65D 25/20; G05B 19/4099

(52) U.S. Cl. CPC G06K 19/0723; B65D 25/205; G05B 19/4099; G05B 2219/49023

(57) ABSTRACT

A food grade taggant for an edible matrix may comprise a light triggered microtransponder comprising a monolithic integrated circuit. The monolithic integrated circuit may be enclosed within a passivation layer that forms a barrier with the edible matrix. The monolithic integrated circuit may have maximum dimensions of 2 mm length, 2 mm width, and 0.2 mm thickness.

### CROSS REFERENCE TO RELATED APPLICATIONS

This application claims priority to U.S. Provisional Application No. 63/375,150, entitled “Biologically Inert And Secure Food Taggant,” filed Sep. 9, 2022, which is incorporated by reference herein in its entirety.

### TECHNICAL FIELD

The present disclosure relates to trackable secure taggants that are part of an edible matrix. Disclosed are methods of inclusion of secure taggants to the edible matrix, and practical applications thereof. Such secure taggants may be food grade (e.g., biologically inert) and therefore maybe edible by humans and/or animals.

### BACKGROUND

The traceability of the origin and the chronological record of food products (generally referred to as an edible matrix), either together or separately, is a key driver of the economic value of the food products and also a critical component of food security. Traceability helps build consumer confidence by allowing consumers to be aware of where and how the food products have been grown or sourced, who and when has been involved in the processing, packaging, and logistics. The chronological record allows one to view or audit the timestamps of various steps involved in processing, packaging, or logistics of the food products. Traceability and the chronological record of the food products (typically understood together as “provenance”) is particularly important for perishable food products that must undergo multiple processing steps (e.g., dairy products, meat, seafood, fish, etc.), and/or pass along complex supply chains (e.g., fruits, vegetables, etc.). Consumers place significant value in the methods by which food is grown, gathered, and processed in case of plant-based food; or how the livestock are caught or raised, tended to, slaughtered, processed or packaged in case of meat or fish. Many distinct categories exist that have designated rules such as organic, non-GMO, pesticide free, sustainably grown, fair trade, wild-caught, and child labor free. While marketers understand that consumers will pay more for foods that meet their choices in these particular categories, the ability to authenticate and verify such claims by neutral third parties has unfortunately been an exception, not the norm, thereby enabling opportunities for false claims and counterfeit labeling.

Furthermore, there is a growing trend of consuming “lab-grown meat”. Lab-grown meat, also known as cultured meat or cell-based meat, is a type of meat that is produced using in vitro cell culture techniques, rather than by raising and slaughtering animals. It involves growing animal muscle cells or animal muscle-like cells in a controlled environment, such as a laboratory, using a combination of biotechnology, tissue engineering, and cell culture methods.

Such meat is also manufactured in bulk using biotechnology techniques. Such techniques may include the use of buffers (often culture media), reactors (vessels for carrying out the biochemical transformations); cells of particular cell-line and processing steps. Each of these steps may introduce variables that ultimately impact the quality of the product (i.e., the edible matrix).

Many reasons exist for the lack of transparency in the food supply chain, and the conventional technology has been unable to addresses these reasons. For example, there is a lack of availability of affordable, durable, secure digital taggants for edible and/or food contact applications. There is also a lack of common standards that can be implemented across a large numbers of service providers and points of sale. While many consumers make purchasing decisions based on brands, which often extol unverifiable claims on their packaging and digital content (e.g., via weblinks, QR codes, etc.), there is a large and growing desire to have transparency and the ability to have third-party verification of claims for food items throughout the food supply chain and each raw material contained in food products (e.g., processed food).

Conventional technology includes using paper labels, bar codes, and other two-dimensional tags such as QR codes, datamatrix codes, holograms or radio frequency identification (RFID) chips/tags on the food products. Paper labels are easily degradable and typically do not withstand the rough and tumble of being transported across a complex supply chain passing through multiple hands, machines, and vehicles. Bar codes are generally printed on paper labels or other medium and generally suffer from the same degradability issues. Furthermore, these paper labels and bar codes store static, hard-coded non-electronic information, which is limited by the surface area (i.e., there is limit the information that the bar-code of a certain size can store).

RFIDs can store information electronically and may solve the capacity issues associated with physical storage of information through bar codes and labels. RFID chips, however, have multiple components spread across a large surface area. For instance, an antenna of an RFID chip may be unwieldly long and therefore not convenient to be affixed to a food product with a limited surface area. Furthermore, for a food product that produces moisture and/or is stored in a moist medium, the moisture content may negatively impact the functionality of an RFID chip. For example, a wet or moist RFID chip may have to be completely dried off before it becomes functional again. This problem is further exacerbated when the product has to be produced in a wet medium (e.g., a cheese undergoing a saltwater bath).

Furthermore, the large size of the RFID chip allows for an adversarial party to easily locate and remove the chip from the food product for nefarious reasons, e.g., to destroy the provenance of a genuine food product. Generally, RFID chips are not biologically inert and may adversely affect the consumers'health, if ingested in whole or in part.

Accordingly, a significant improvement in food product taggants is therefore desired.

### SUMMARY

In some embodiments, this disclosure relates to a food grade taggant for an edible matrix, including: a light triggered microtransponder including a monolithic integrated circuit; the monolithic integrated circuit enclosed within a passivation layer that forms a barrier with the edible matrix; and the monolithic integrated circuit having maximum dimensions of 2 mm length, 2 mm width, and 0.2 mm thickness.

In some embodiments, this disclosure relates to a food grade taggant for an edible matrix, including: a light triggered microtransponder including a monolithic integrated circuit; and the monolithic integrated circuit enclosed within a passivation layer that forms a barrier with the edible matrix.

In some embodiments, this disclosure relates to a system of tagging an edible matrix, the system including: a plurality of food grade taggants, each including: a light triggered transponder including a monolithic integrated circuit; and the monolithic integrated circuit enclosed within a passivation layer that forms a barrier with the edible matrix.

In some embodiments, this disclosure relates to a method including: associating a food grade taggant with an edible matrix, the food grade taggant including: a light triggered microtransponder including a monolithic integrated circuit; the monolithic integrated circuit enclosed within a passivation layer that forms a barrier with the edible matrix; and the monolithic integrated circuit having maximum dimensions of 2 mm length, 2 mm width, and 0.2 mm thickness.

In some embodiments, this disclosure relates to a method including: associating a food grade taggant to an edible matrix, the food grade taggant including: a light triggered microtransponder including a monolithic integrated circuit; and the monolithic integrated circuit enclosed within a passivation layer that forms a barrier with the edible matrix.

In some embodiments, this disclosure relates to a method including: associating a plurality of food grade taggants with an edible matrix, each food grade taggant including: a light triggered transponder including a monolithic integrated circuit; and the monolithic integrated circuit enclosed within a passivation layer that forms a barrier with the edible matrix.

It is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 depicts a block diagram of an example MTP sensor system in accordance with example embodiments of the present disclosure.

FIG. 2 illustrates a schematic diagram of an example MTP in accordance with example embodiments of the present disclosure.

FIG. 3 illustrates a side view representation of an illustrative MTP in accordance with example embodiments of the present disclosure.

FIG. 4 illustrates a top plan view representation of an illustrative MTP in accordance with example embodiments of the present disclosure.

FIG. 5 depicts a functional block diagram of an illustrative MTP in accordance with example embodiments of the present disclosure.

FIG. 6 is a schematic diagram of a clock recovery circuit in accordance with example embodiments of the present disclosure.

FIG. 7 illustrates a cross-section view of an example photoconductor in accordance with example embodiments of the present disclosure.

FIG. 8 illustrates a timing diagram of the light intensity and the voltage signal at each node of the clock recovery circuit with a coupling capacitor of FIG. 6, in accordance with example embodiments of the present disclosure.

FIG. 9 illustrates a functional block diagram of a MTP reader in accordance with example embodiments of the present disclosure.

FIG. 10A illustrates in simplified form how a string of “1101” is transmitted under an old system, and FIG. 10B illustrates in simplified form how a string of “1101” is transmitted under a reverse antenna system described herein, respectively.

FIG. 11A shows one example diagram of reversing the direction of antenna operation in in accordance with example embodiments of the present disclosure.

FIG. 11B shows another example diagram of reversing the direction of antenna operation in accordance with example embodiments of the present disclosure.

FIG. 12 shows an example tagging system for an edible matrix in accordance with example embodiments of the present disclosure.

FIG. 13 shows an example taggant system in accordance with example embodiments of the present disclosure.

FIG. 14 shows an example taggant system in accordance with example embodiments of the present disclosure.

FIG. 15 shows an example taggant system in accordance with example embodiments of the present disclosure.

FIG. 16 shows an example taggant system in accordance with example embodiments of the present disclosure.

FIG. 17 shows an example taggant system in accordance with example embodiments of the present disclosure.

FIG. 18 shows an example taggant system in accordance with example embodiments of the present disclosure.

FIG. 19 shows a flow diagram of an example method of tagging an edible matrix, according to example embodiments of this disclosure.

### DESCRIPTION OF THE EMBODIMENTS

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

As used herein, an edible matrix should be understood to include any kind of food product or edible material. Non-limiting examples include naturally grown foods (e.g., fruits, vegetables), animal-based foods (e.g., milk, eggs, fish, meat, and cheese), processed foods (e.g., cured meats, cheese), lab-grown foods (e.g., lab-grown meat products), etc. Although “food” and “food product” monikers are used below for convenience and brevity, these embodiments are applicable to any kind of edible matrix. The edible matrix can be edible to humans and/or animals. Further, the edible matrix may be cultivated, obtained from an animal, cultured in lab by biotechnology techniques, or may be processed and/or shaped into any form, using techniques such as three-dimensional printing (3D-printing).

As used herein, ingestible refers to any substance that may be taken into the body by swallowing or eating, and passing through the alimentary canal without causing any harm to the body. Digestible refers to materials that can be broken down to smaller or simpler constituents by the digestive system to extract the nutrients may be extracted. Not all ingestible material may be digested, whereas nearly all digestible material may be ingested.

As used herein, food grade should be understood to mean the properties of the taggants that allow the taggants to safely come in contact with the edible matrix and to safely pass through the alimentary canal of humans and/or animals without causing adverse effects. For example, the monolithic microtransponders described throughout this disclosure may comprise a passivation layer that encloses circuitry, where the passivation layer maintains the integrity of the microtransponders in the biochemical environment of human/animal alimentary canal. That is, the monolithic microtransponders cannot be digested and absorbed even when ingested.

It is understood that traceability enables a greater degree of food safety as it enables an identification of events and/or sources of contamination—a key cause of preventable foodborne illnesses. Based on the precision of a technique, it may be possible to identify a single item in a packaging containing multiple items, or even a fractional piece of a larger item. For instance, it may be possible to uniquely identify a single wedge of cheese amongst a cheese wheel comprising multiple cheese wedges, contained in box with multiple cheese wheels, and within a pallet containing many such boxes. Should the cheese wedge be fouled or moldy, it would be possible to identify and discard the individual cheese wedge and discard it, preventing the mold from spreading through the pallet while maintaining traceability of other wedges in the pallet.

Similarly, traceability also helps with recall of such contaminated food products, as it enables an identification of all parties involved in handling the material (also known as the “chain of custody”), and alert those involved. Contaminants in the foods could include environmental specimens, artifacts of food processing, allergens, adulterants, or migrants from the packaging material. Should a source of contamination be introduced during a processing, or during logistics, it would be possible to identify the precisely the subset of food products that were contaminated by that source, allowing only those that came into contact with the contaminant to be discarded or processed separately. This translates to minimal loss in the event of a contamination. An example application of this precise traceability is spoilage due to customs and security checks at border crossings, where only sample of food items is exposed and tested (e.g., using sniffer dogs).

Records of the chain of custody can be maintained, in electronic or physical format for any required time, such that the records may be audited by a relevant authority, which may issue a recall if a batch of products is found to be contaminated or unfit for human or animal consumption. Should the authority identify that a particular batch of food products has been contaminated before all steps in the supply chain are complete, it might be possible to effectuate a recall early in the process before food product reaches the consumer market, thereby preventing a potential public health hazard.

One technique of enabling the traceability of food is an inclusion of a unique feature or element, with or within the food product, that can be repeatedly and indelibly “read” (or scanned) to register the response. It would be beneficial if the unique feature is food grade, i.e., as described above, there is no harm upon consumption by humans or animals. The responses from the multiple reads can be logged chronologically (e.g., at a server, some portion of the multiple reads may be logged in the element itself), thereby forming the record (or the chain of custody). The said feature/element may be an overt marking such as a printed bar code, holograms, Quick Response or QR code, etc. or a covert marking such as RFID (Radio Frequency Identification), Near Field Contact (NFC) based chip or secure inks that bear a unique spectroscopic signature. When the unique feature/element is difficult to replicate, such a feature/element may also become an additional security element.

The food products may be in forms such as a solid, a paste, a viscous liquid or, a non-viscous liquid. The unique feature/element may be added to the food product, such that it may be part of the bulk, be present on surface or in contact with the food, sometimes as a separate or integral part of the embellishment or packaging, or sometimes present remotely as part of an encasement of the food material. The unique feature/element may be introduced at the origin of the source of the food product, at an early step in the processing of the food product, at a later stage, or just prior to being made available to the consumer. The unique feature/element is likely to be provide a larger utility, however, if it is introduced early on the food processing.

Optically Activated Microtransponders (MTPs) and All Optical Micro-transponders (OMTPs)—a subclass of MTPs, are particularly qualified as security elements. As described herein, MTPs and OMTPs may wirelessly transmit a unique and an incorruptible digital identifier, when scanned with a suitable device (“a reader”). The transmitted signal may be in the form of a radio frequency (RF) signal in case of MTPs, and light in the case of OMTPs. The identifier may be used for the purpose of identifying a tangible object (such as food product), when the transmitted identifier and tangible object are linked, via a database. Their small size, (typically less than 2000 microns along its longest side, preferably less than 600 microns along its longest side), durability, and inertness to a variety of biological and chemical media make MTPs particularly attractive as taggants. The aforementioned sizes are provided as examples and should not be considered limiting. Further MTPs can be easily combined with other security elements (such as QR-codes, holograms, etc.) to form “compound taggants”. Such compound taggants may contain the MTP / OMTP present overtly or covertly. Further, a single reader may be able to read the multiple security elements at once. For the sake of brevity, the description below uses the term MTPs, but the embodiments should equally apply to OMTPs as well. Some embodiments of MTPs are commercially available as p-Chip™ from p-Chip corporation of Chicago, IL.

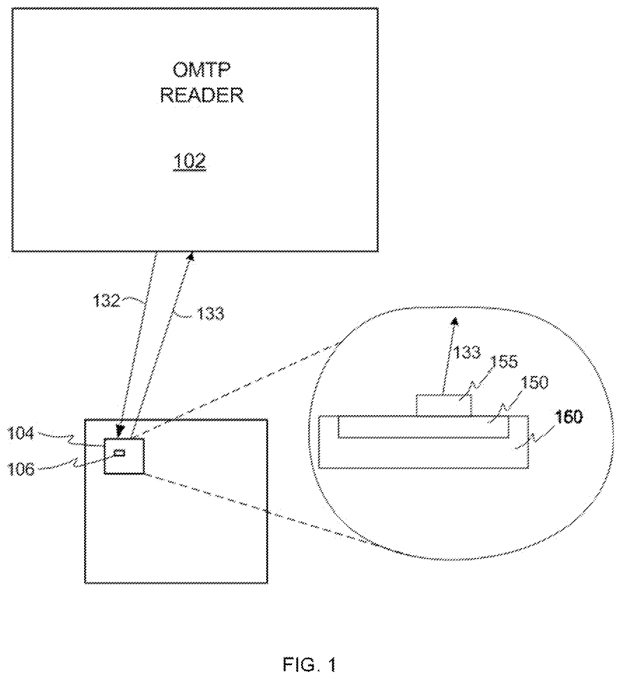

FIG. 1 depicts a block diagram of MTP sensor system 100 (“system 100”) in accordance with some embodiments of the present disclosure. The system 100 comprises a MTP reader 102 and an MTP 104. In some embodiments, the MTP 104 is associated with an edible matrix so as to operate as an identifier for the edible matrix. The MTP 104 may be adhered to, implanted within, or otherwise attached to the edible matrix requiring individual unique identification (ID) data. An enlargement of the MTP 104 is depicted in the breakout shown in FIG. 1 to illustrate MTP components comprising a substrate 160, photo elements 150, and an optical communication circuit 155. The height of the MTP 104 can be, for example, approximately 20 μm-60 μm and dependent on the number of stacked layers and sensors for a particular MTP 104. The MTP 104 may be an integrated circuit which may be normally in a persistent dormant unpowered state until powered on when illuminated with an excitation beam 132 from the MTP reader 102. Upon illumination, the MTP 104 may power on (generally instantly, e.g., much less than 1 second) and transmit a data beam 133 via light to the MTP reader 102. The data beam 133 in some embodiments may be an emission (e.g., from a light emitting diode (LED)) or, in other embodiments, a reflection/absorption mechanism (e.g., shuttering via liquid crystal display (LCD)). In alternative embodiments, the MTP 104 receives a separate stimulus such as a code modulated onto the excitation beam 132 which initiates transmission of data from the MTP 104. Alternatively, receiving data from an internal or linked sensor may trigger a transmission of the data beam 133.

In some embodiments, the excitation beam 132 is a visible focused light or laser beam, and the data beam 133 is an infrared light beam emission (e.g., from an infrared emitting diode). The data beam 133 may contain a signal to identify the specific MTP 104 to the MTP reader 102, for example using an identification number unique to the specific MTP 104. Using the unique identification information, the MTP reader 102 may transmit data to a computer (not shown) to uniquely identify the edible matrix. In some embodiments, a user may operate the MTP reader 102 to illuminate the MTP 104 with a light or other electromagnetic signal that causes the MTP 104 to transmit the data beam 133 via light or other electromagnetic signal. For example, in some embodiments the range of electromagnetic spectrum used by MTP 104 for this signaling may include one or more subsets of the sub-terahertz portion of the spectrum, including infrared and longer wavelengths. The data beam 133 may be received by the MTP reader 102. The MTP reader 102 then may decode the data beam 133 carrying identification data to unambiguously identify the object.

“Laser” shall be defined herein as coherent directional light which can be visible light. A light source includes light from a light emitting diode (LED), solid state lasers, semiconductor lasers, and/or the like, for communications. The excitation beam 132 in some embodiments may comprise visible laser light (e.g., 660 nm wavelength). In some embodiments, the excitation beam 132 in operation may illuminate a larger area than that occupied by the MTP 104, thereby allowing a user to localize and read the MTP 104. In some embodiments, the excitation beam 132 may comprise other wavelengths of light in the visible and/or invisible spectrum to supply sufficient power generation using photo elements 150 of the MTP 104. The data beam 133 may be emitted with a different wavelength than the excitation beam 132. For example, the data beam 133 may be 1300 nm IR light while the excitation beam is 660 nm red light. However, other wavelengths, such as the near-infrared (NIR) band, may be used for optical communication and alternative embodiments may use other communication techniques such as reflective signaling methods to return a modulated data signal to the MTP reader 102. In some alternative embodiments, the MTP 104 comprises an antenna (e.g., an integrated antenna) for communicating ID information to the MTP reader 102 via radio waves rather than a light-based signal.

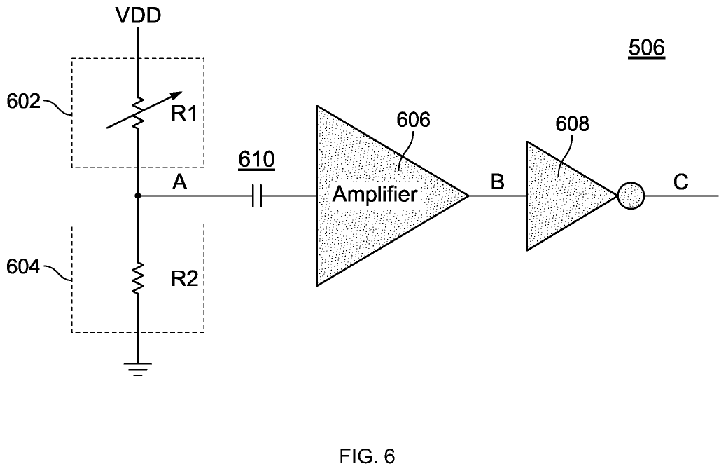

In some embodiments, the MTP 104 may comprise a clock recovery circuit 106. The clock recovery circuit 106 may extract a clock pulse signal from the received modulated light beam as described in detail further below with respect to FIGS. 6-8. In one embodiment, the light of the excitation beam 132 is amplitude modulated (e.g., pulsed) at approximately 1 MHz to provide the data clock which may be used by the MTP 104 for supplying the operation clock pulses, for example, of transmitted ID data bits. The timing of the pulse groups can be set so that the duty cycles and average power levels fall within requirements for registration as a Class 3R laser device.

An example MTP can be a monolithic (single element) integrated circuit (e.g., 600 μm×600 μm×100 μm) that can transmit its identification code through radio frequency (RF). This dimension is just an example and should not be considered limiting. For example, the monolithic integrated circuit may have maximum dimensions of 2 mm length, 2 mm width, and 0.2 mm thickness.

When there are a plurality of MTPs, each MTP (e.g., MTP 104) may have a unique serial number or identifier (ID) programmed or otherwise assigned thereto. MTPs may be read by the MTP reader 102 (e.g., a wand) with no duplicate IDs. The MTP reader 102 may be a hand-held device connected to a standard Windows PC, laptop or tablet used to read the MTP and may be capable of reading the serial number or ID of individual MTPs.

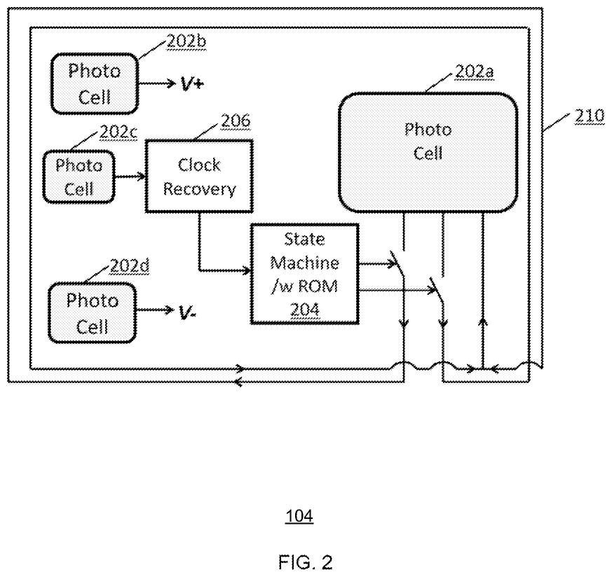

FIG. 2 illustrates a schematic diagram of an example MTP 104 in accordance with some embodiments of the present disclosure. As shown, the MTP 104 may include photocells 202a, 202b, 202c, 202d (commonly referred to as a photocell 202 and collectively referred to as photocells 202); clock recovery circuit 206 (e.g., clock signal extraction circuits); a logical state machine 204; a loop antenna 210; and a 64-bit memory (not shown) supporting, for example, over 1.1 billion ID codes. The photocells 206, when illuminated by a pulsed laser, may provide power to the electronic circuits on the chip with, for example, ˜10% efficiency. The MTP 104 may transmit its ID through modulated current in the antenna 210. The varying magnetic field around the MTP 104 may be received by a coil in the reader, and the signal may be digitized, analyzed, and decoded. MTPs (such as the shown MTP 104) may be manufactured on silicon wafers in foundries, using CMOS processes similar to those used in the manufacturing of memory chips and computer processors. Wafers may receive post-manufacturing treatment including laser encoding, passivation, thinning, and dicing to yield individual MTPs. For example, the MTP 104 surface may be made of silicon dioxide, which is deposited as a passivation layer. The silicon dioxide used as a passivation layer is just an example material and should not be considered limiting. The passivation layer encloses the other components and forms a chemical and biological barrier. Therefore, the MTP 104 can safely pass through human/animal alimentary canal thereby making the MTP 104 food grade.

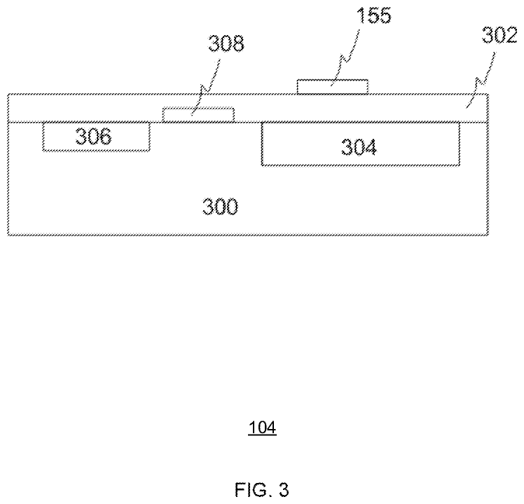

FIG. 3 illustrates a side view representation of an illustrative MTP 104 in accordance with at least one embodiment of the invention. The MTP 104 may comprise a stack of individual integrated circuit layers 300, 302, 304, 306, 308. Within the shown individual layers, the layer 302 may support a passivation layer (i.e., receive the material forming the passivation layer). The layer 304 may comprise logic, clock, sensors, and transmitter circuits. Layers 306, 308 may comprise storage capacitors; and 300 may be the substrate. Those of skill in the art will recognize that functions of the MTP 104 can be organized into layers of other configurations. For example, the stacking may comprise layers of differing thicknesses uniformly overlaid so that they can be manufactured for example in a 3D IC process well-known in the art.

The MTP 104 may be manufactured using mixed-signal manufacturing technology that is typically used to make sensor electronics or analog-to-digital converters which comprise both analog and digital devices together. In an example embodiment, each layer is approximately 12 μm thick and 100 μm×100 μm in dimension. In one embodiment, dimensions of the MTP 104 are 100×100×50 μm. Alternative embodiments may use more or less layers as depending on the application.

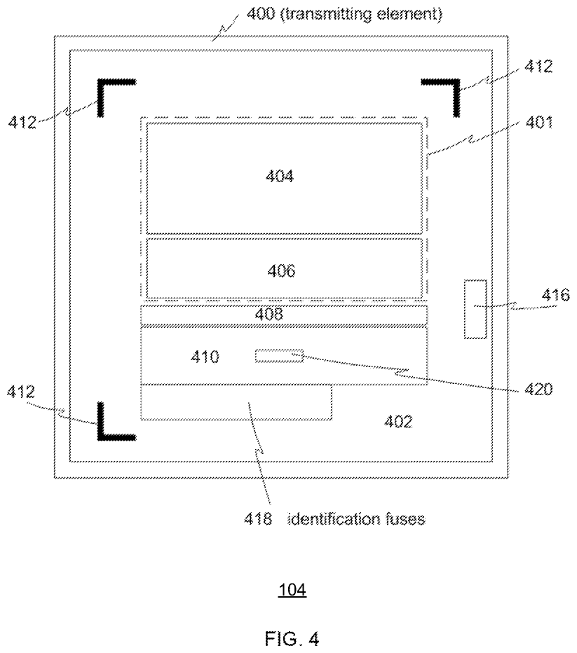

FIG. 4 illustrates a top plan view representation of an illustrative MTP 104 according to some example embodiments of this disclosure. The view depicted in FIG. 4 is of the top layer 302 of FIG. 3. In one embodiment, on top of the layer 302 comprises a transmitting element, such as an LED array 400, that circumscribes the periphery of the MTP 104. In other embodiments, an LED array may be realized as a single LED in the middle of logic/sensor circuits 410 (shown in phantom as LED 420) or other topography for directed light emission. The placement of the LED array 400 depicts an example of an embodiment emphasizing light generation. Alternative embodiments may include varying topography layouts favoring power harvesting or capturing sensor data and the like. In some embodiments, the LEDs may include focusing lenses or other optics.

Centrally located on the top layer 302 is an array 401 of photocells 402, 404, 406, and photoconductor 408. As illustrated, each photocell in array 401 can be physically sized to create power for a particular circuit within the MTP 104 and one can be dedicated to clock/carrier signal extraction as described below with respect to FIG. 4. Photocell 402, the largest in area, produces a voltage V_{dd} (in some embodiments, a negative voltage, V_{neg}) for operating an output transistor 416 to drive the electronic radiation transmitter (realized in some embodiments as an LED in the optical communication circuit 155). Photocell 404 produces a positive voltage for logic/sensor circuits 410, and photocell 406 produces a negative voltage, V_{neg}, for logic/sensor circuits block 410. Photoconductor 408 is used to extract clock pulses, e.g., for operating the logic/sensor circuits 410. The photocells 401 may be coupled to capacitors, for example, in layers 306 or 308 for storing the energy produced by the photocells when illuminated by laser light. In some embodiments, energy extracted from the clock photoconductor 408 is applied to a differentiator (described below with respect to FIG. 6) which extracts clock edges which are amplified and used to provide timing signals to the logical and sensing circuits. As illustrated, a plurality of identification fuses 418 is located on the surface 414. By opening select ones of these fuses, the MTP 104 is provided a unique identification code range beyond a default base page of code values that may be hard-coded into the chip logic. In an alternative embodiment, the ID values may be electronically coded using electronic antifuse technology. Further still are embodiments with electronic memory for data, signal processing, and identification storage.

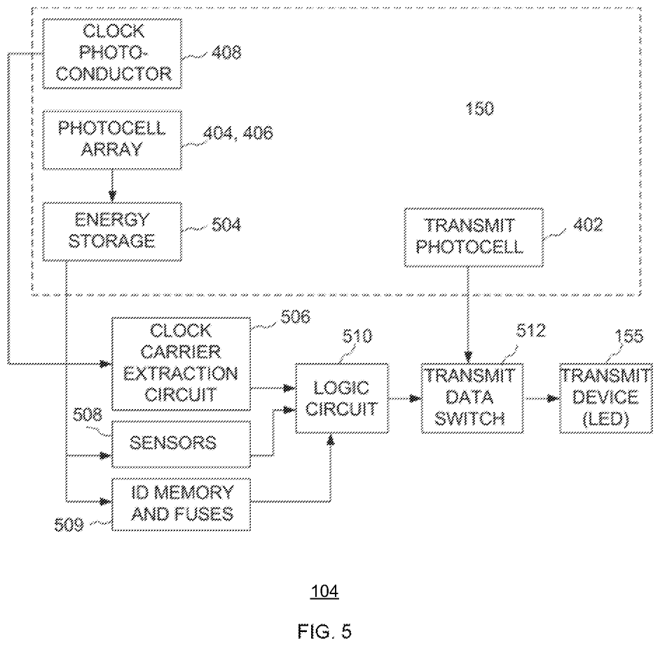

FIG. 5 depicts a functional block diagram of an illustrative MTP 104 in accordance with some embodiments of this disclosure. The MTP 104 may comprise the photo elements 150, energy storage 504, clock/carrier extraction network 506 (i.e., clock recovery circuit 106), sensors 508, logic 510, transmit switching circuit 512, and an infrared (IR) LED 155. The photo elements 150 can include dedicated photocells such as the clock extraction photoconductor 408, the energy harvesting photocell array 404, 406, and the transmit photocell 402. The energy harvesting photocell array 404 and 406 may be coupled to energy storage 504 and may comprise photovoltaic cells which convert light energy from illumination into an electrical current.

The clock photoconductor 408, which is part of the clock recovery circuit and can be physically located in different places from the recovery circuits, may detect a clock pulse signal for the clock/carrier extraction circuit 506. In some embodiments, the energy storage 504 comprises a plurality of capacitors having at least one capacitor coupled to a photocell of the photocell array 404, 406. The energy stored in the energy storage unit 504 may be coupled to the electronic circuits. Since the laser light is pulsed, the energy from the laser may be accumulated and the MTP 104 may operate on the stored energy. Unlike the photocell array 404 and 406, the energy of photocell 402 is not stored and the transmitter switching circuit 512 via output transistor 416 can “dump” all of its energy into the transmit element 155. As the received laser pulse energy is extracted by the clock/carrier extraction circuit 506, the logical state machine (i.e., logic 510) may form data packets comprising the ID bits and sensor data and provide these to the transmit data switch 512 for the formation of the optical transmission signal. The logic 510 may directly integrate the sensor and ID signal(s) into a composite data frame of the OOK (on-off keyed) emitter. The modulation symbols may be applied to the transmitter 512 and transmitted with each pulse of energy.

In some embodiments, the MTP 104 may include sensor(s) 508. The sensor(s) 508 can comprise one or more sensors, for, for example, measuring properties of the edible matrix. Any analog data from the sensor(s) 508 may be converted into a pulse width modulated signal or other binary signaling method that encodes the analog quantity in the time domain in a manner suitable for pulsing the IR emitting diode for direct transmission to the MTP reader 102 without the need for traditional, power and area intensive analog to digital conversion techniques. Example sensors include, but are not limited to, a dielectric sensor, a proportional to absolute temperature (PTAT) sensor, a pH sensor, a redox potential sensor, and/or light sensor. However, other types of sensors are also to be considered within the scope of this disclosure.

FIG. 6 is a schematic diagram of a clock recovery circuit 506 in accordance with some example embodiments of this disclosure. The clock recovery circuit 506 may comprise a photoconductor 602 having a resistance R1 that varies as a function of received light intensity, a reference resistor 604 having a fixed resistance R2, an amplifier 606, and an inverter 608. A source terminal of the photoconductor 602 is coupled to a first terminal of the resistor 604 at a node A. Node A is coupled to the input of the amplifier 606, and the output of the amplifier 606 is coupled to the inverter 608 which generates the recovered clock circuit at its output.

The series combination of the photoconductor 602 and the resistor 604 form a voltage divider R that is coupled between a voltage V_{DD} and ground. Specifically, in this embodiment, a drain terminal of the photoconductor 602 is coupled to the voltage V_{DD} from the energy storage 504, which sustains the voltage when the illumination is off, and the second terminal of the resistor 604 is coupled to ground. Since the resistance R1 of the photoconductor 602 varies as a function of received light intensity, and the voltage at node A is determined by the ratio of the resistances R1 and R2, a modulated light input incident on the photoconductor 602 produces a modulated voltage signal at the input of the amplifier 606.

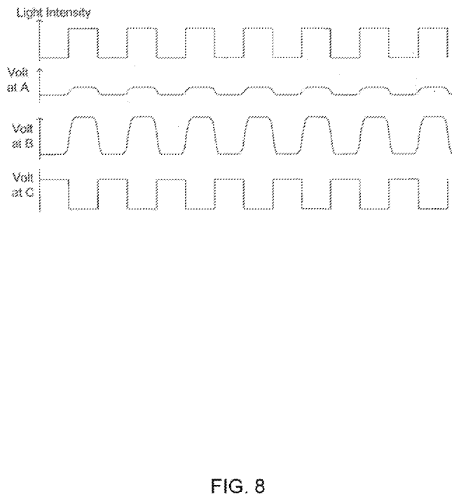

In some embodiments, a coupling capacitor 610 is added in front of the amplifier 606. The voltage divider R and the coupling capacitor 610 form a differentiator which may extract clock edges when the modulating frequency is as low as a few kilohertz (at approximately 1 MHz or above, this may not be necessary). The inverter 608 digitizes the analog output of the amplifier 606, resulting in an example digital waveform as shown in FIG. 8, as described below.

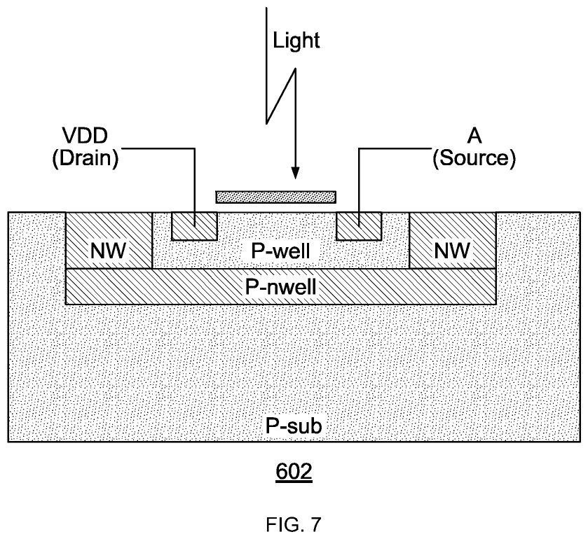

FIG. 7 illustrates a cross-section view of an example photoconductor 602 in accordance with some embodiments of the present invention. In some embodiments, the size of the photoconductor 602 can be 5 μm×5 μm or larger. As illustrated, the photoconductor 602 may employ a long channel n-MOSFET in an isolated deep n-well bucket. The n-wells and the deep n-well (D-nwell) may completely seal the p-well, in the p-substrate, and the transistor components, i.e., the source, drain, and gate which are confined in the bucket. The gate layer, for example made from polysilicon material, may be disposed on top of an insulating layer, such as silicon dioxide (SiO₂). The polysilicon material spectrum-wise absorbs shorter wavelength light, such as blue light, but passes longer wavelength light, such as red light. When using an excitation beam 132 having a longer wavelength, such as a red-light beam, the polysilicon material filters and blocks the shorter wavelengths and passes the long wavelength. As such, it suppresses shorter wavelengths. For example, a room light (e.g., a fluorescent lamp) that flickers at the speed of 60 Hz may produce some interference or noise having more spectrum in the shorter wavelength (blue wavelength) range, and the polysilicon material effectively blocks the flickering from the room light and only passes the desired energy beam (e.g., the red light).

Further, the photoconductor 602 (which may also be referred to as a photoresistor) allows the clock recovery circuit 106 to function under both low illumination and high illumination conditions in contrast to photodiode-based clock recovery circuits. For example, under sufficiently high illumination, excessive flooding charges in a photodiode cannot be sufficiently discharged, resulting in the malfunction of a photodiode-based clock recovery circuit. In contrast, the photoconductor 602 can be operated in current mode and may be less affected by the high illumination flooding phenomenon since photo charges are drained constantly by the electric field in the photoconductor 602. Additionally, the deep n-well bucket of the photoconductor 602 is isolated such that the n-wells physically form a potential barrier that prevents charges generated outside of this bucket from entering the bucket, ensuring that only those photons arriving inside the bucket can contribute to the conductivity of the photoresistor 602. As such, excessive photogenerated charges during high illumination, which may result in malfunctioning of photodiode-based clock recovery circuits, is suppressed in the clock recovery circuit 106.

Additionally, this FET device may have a very small physical footprint. For example, the inverter 608 as shown in FIG. 6 can comprise a static CMOS inverter device comprising an NMOS and a PMOS transistor and having two states, either high or low. If the inverter input is above a reference voltage, it is considered to be high, below the reference voltage is considered to be low, and then the output is inverted. The static CMOS inverter can also act as an analog amplifier as it has a sufficiently high gain in its narrow transition region to amplify the signal, enabling the clock recovery circuit 506 to have a very small footprint. In instances where the extracted clock pulse is extremely low, amplification by the amplifier 606 may not be sufficient to reach the threshold voltage for flipping the logic state; in these instances, the inverter 608 can further boost the overall amplification to reach its threshold.

FIG. 8 illustrates a timing diagram of the light intensity and the voltage signal at each node of the clock recovery circuit 506 with a coupling capacitor of FIG. 6.

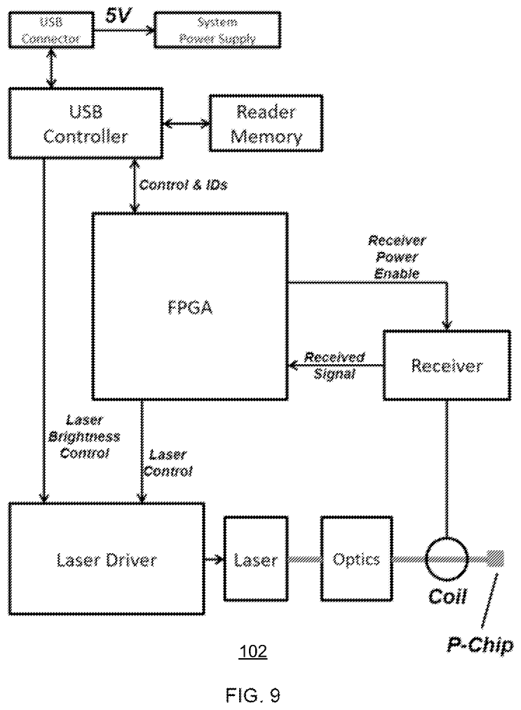

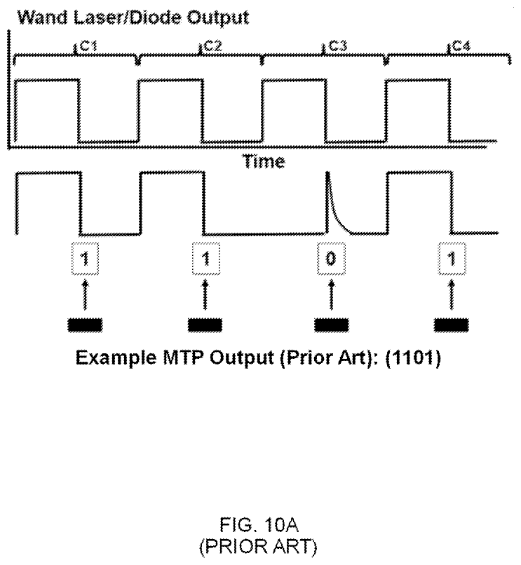

FIG. 9 illustrates a functional block diagram of a MTP reader 102 in accordance with some embodiments of the present disclosure. As illustrated in FIG. 9, an example MTP reader 102 may be USB-powered and may include a USB 2.0 transceiver microcontroller, a field programmable gate array (FPGA), power converters and regulators, a laser diode with the programmable current driver, an optical collimation/focusing module, and a tuned air coil pickup with a high-gain, low-noise differential RF receiver. The example laser emits an average of 60 mW of optical power modulated at 1 MHz at 658 nm wavelength when reading a MTP ID. The ID is read when the MTP is placed within suitable proximity (e.g., <10 mm) from the MTP reader 102. The MTP generated waveform is compared to the data clock (Laser Modulation) used for the synchronization of the transmitted ID data bits. The resulting ID readout from the MTP is rapid (<0.01 s) and is reported on the PC or tablet. The MTP reader 102 may be able to read MTP under challenging conditions, such as through a sheet of white paper, blue-colored glass (˜1 mm thick), or a sheet of transparent plastic laminate. Other MTP readers have been developed (e.g., an instrument for reading IDs with the MTP in a fluid). Another version in development is a battery-operated Bluetooth reader that can be used with a PC or cell phone.

Some embodiments may provide efficient systems and methods capable of increasing the signal strength emitted by these small MTPs. The MTP data may be transmitted using a data coding that results in one third to two thirds of the transmitted bits having a value of one. The average for all IDs may be half of the data having a value of one. A “1” digital signal is transmitted with the laser on and a “0” digital signal is transmitted with the laser off (The photocell stored energy provides a small amount of energy to be transmitted). The signal power tracks the ratio of ones to zeros in the data. Some embodiments may transmit a “1” digital signal the same as it currently is transmitted, but a “0” digital signal is transmitted with the laser ON with the current flowing in the opposite direction of the current for a “1” digital signal. This results in all IDs being transmitted with the same power. Data may be transmitted when the laser is on. This may result in twice the power in the transmitted signal (6 dB more signal in the receiver, on average). The method may result in easier signal processing and easier differentiation of ones and zeros. This may lead to a MTP reader 102 with a greater read distance and simpler processing.

For example, the MTP 104 may be queried with a light flashing at 1 MHz with a 50% duty cycle. This may be accomplished with a laser or a focused LED, or the like.

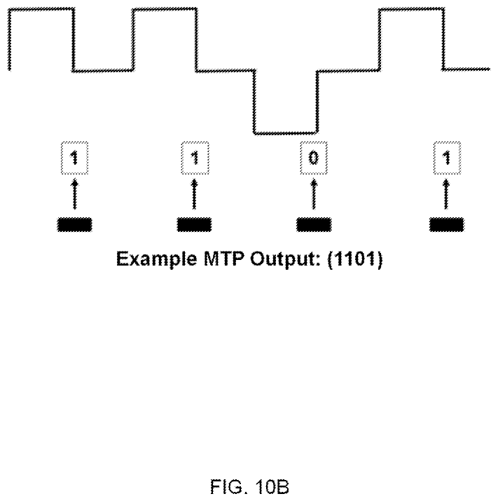

FIG. 10A illustrates in simplified form how a string of “1101” is transmitted under an old system, and FIG. 10B illustrates in simplified form how a string of “1101” is transmitted under a reverse antenna system described herein, respectively. For each off/on cycle, such as c1, c2, c3 or c4 of FIGS. 10A-10B, the MTP reader may seeks 102 a radio signal identifying a “1” digital signal or “0” digital signal transmission. As shown in simplified form, for the first illustrative MTP output of FIG. 10A illustrating a prior art system, zeros are transmitted when the light source is off. However, the photocell capacitance used to transmit the zero is limited. In fact, this limited signal denotes a “0.” The limited energy applicable to zero means that signal-to-noise at the MTP reader 102 is restrained by the signal to noise ratio (SNR) for the zero. This means that while in principle the “1”s can be read at a significantly greater distance, MTP signal may only be read at the shorter distance applicable to the “0” components of the signal. A method is provided herein that includes reversing the direction of the current in the RF output antenna to transmit a “0” digital signal so as to use substantially the same current for the “1” digital signal and the “0” digital signal (see FIG. 10B). In some embodiments different from FIG. 10B, any given bit (“1” or “0”) or digital signal in the p-Chip™ MTP may be transmitted within 8 consecutive light cycles.

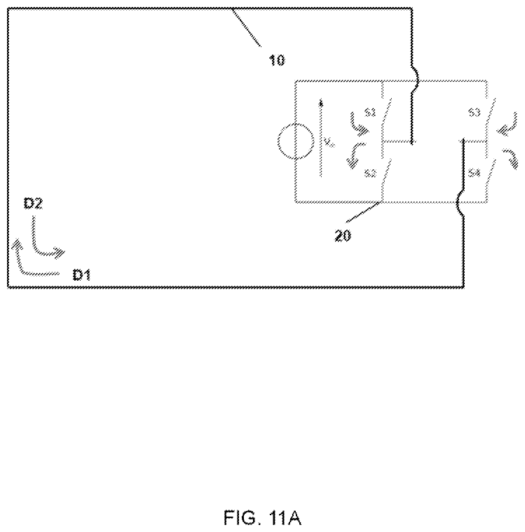

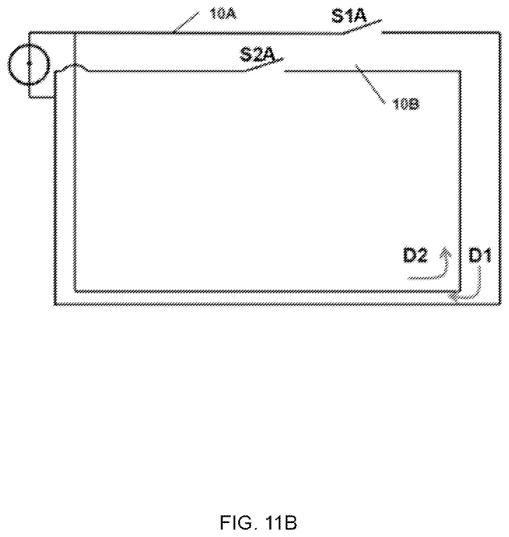

One way of reversing the antenna current is to use a switching circuit such as an H-bridge. FIG. 11A shows one example diagram of reversing the direction of antenna operation in accordance with some embodiments of the present disclosure. As shown in FIG. 11A, an antenna 10 may be operated by a voltage source Vin and an H-bridge 20. Selectively closing switches S1 and S4 may direct a current through the antenna 10 in the direction indicated by the arrows. Selectively closing switches S2 and S3 may direct a current through the antenna 10 in an opposite direction.

FIG. 11B shows another example diagram of reversing the direction of antenna operation in accordance with some embodiments of the present disclosure. Another way of reversing the antenna current is to use two switches, such as S1A and S2A in FIG. 11B, and two antennas (e.g., 10A, 10B). Selectively closing switch S1A may direct a current through the antenna 10A in one direction indicated by the arrow. Selectively closing switch S2A may direct a current through the antenna 10B in an opposite direction. If S1 is selectively closed, current moves in direction D1. If S2A is selectively closed, current moves in direction D2, opposite the direction D1. The antenna may be formed in separate metal layers, or on the same layer. Only one FET (S1A or S2A) may be closed at any given time. When either FET is turned on a reverse current may be coupled into the other antenna. The body diode of the off FET may provide a current path for the coupled signal.

In some embodiments, the antenna options described herein may be effected in a monolithic integrated circuit. In some embodiments, the monolithic integrated circuit may be sized about 2 mm×2 mm×0.2 mm or less in thickness.

In some embodiments, the signal strength for a MTP incorporating the above-described bi-phase transmission is increased by about 6 dB. This will increase the reliable read distance of the MTP reader 102. In some embodiments, the number of cycles committed to transmitting a one bit is 8 data periods. Each laser cycle is one data period. Every time the number of data periods is doubled there is a signal processing gain of 3 dB. Eight data periods is 3 doublings (2,4,8). This results in a signal processing gain of 9 dB. By being increased from 8 to 64 (2, 4, 8, 16, 32, 64) or 128 (2, 4, 8, 16, 32, 64, 128) the signal processing gain may increase from 9 dB to 18 dB (for 64 repeats) or 21 dB (for 128 repeats). The current MTP using a repeat of 8 times for its 64 data cells when using a laser at 1 MHz may transmit IDs at a rate of 2,000 per second. By increasing the repeat rate to 128 the read rate may decrease to 128 reads per second with a signal gain of 21 dB. This may result in an increased read distance. The laser rate may be increased or decreased (e.g., in a range of 500 KHz to 5 MHz). The repeat rate may be controlled by selecting one of 8 repeat rates (3 addition memory bits).

### Multiple MTP Indexed Security Feature

The present invention may use authentication of multiple microtransponders, or combinations of microtransponders and taggants (e.g., QR codes, barcodes, RFID tags, etc.) as matched pairs to establish a higher level of security. All taggants must be present and readable to validate the contents. The taggants may be placed next to one another or at different locations on the surface of the object or within the object, and/or at least two different types of security markings can be combined to form a compounded security marking. Failure of any microtransponder or other taggant to respond may indicate non-authentic contents. At least one microtransponder in the multi-level indexing sequence may be a fragile chip that may be rendered physically unable to respond when the container is initially opened. Fragile chips can be produced by post fabrication processing, i.e., thinning of the chip substrate to ensure it breaks when bent or removal from the substrate is attempted. In some embodiments, a method for ensuring chip incapacitation may be implemented by designing a fracture plane or cutting a slot into the chip to disconnect the antennae.

In one embodiment, a physical object (e.g., a container) may be attached with chip A and chip B from a legitimate pairing when both signals respond to interrogation.

In one embodiment, if a physical object is only attached with chip A and chip B is not physically present for interrogation by the reader, a reader may not authenticate this product as the database needs a response from both chips. If the physical object has both chip A and chip B present, but chip B may be broken on opening, the reader may not authenticate this product as chip B is incapacitated.

In one embodiment, similar to the example of the physical object with chip A and chip B, the physical object may have a different pairwise or legitimate pairing indexing via chip C and chip D. While the pairing of chip C and chip D may be legitimate, it may be unique and not equal to the pairing of chip A and chip B. If counterfeiters acquire chips A and C and add them to their packages. The reader may be unable to authenticate the chips as chip A and chip C do not constitute a legitimate pairing.

### Enhanced Read Distance Microtransponder (MTP)

The current generation MTP may have limited read capability when attached directly to metal substrates. Modulated light required to activate solar cells of a MTP may interact with the metallic substrate which may generate eddy currents in the metal. The generated eddy currents may reduce the RF signal intensity response from the MTP. The ability to successfully acquire and decode the RF signal containing the unique identity number of a MTP is a function of a signal distance between the MTP and its reader.

Embodiments of the present disclosure describe techniques of enhancing read distance for MTPs by eliminating the eddy currents. Signal distance for microtransponders directly attached to metallic surfaces may be reduced by up to 30% compared to non-metallic substrates. The enhanced read distance MTP may be embedded with durable self-destructive PUF functions as described. It may be possible to build a physical gap between metal substrates and objects effected by eddy currents. Such schemes may rely on tapes, shims or filled polymeric adhesives, laminates or films that are external to Integrated Circuit (IC) manufacture and structures. Given the wide range of substrates and attachment methods for end use applications of a P-Chip™ MTP, a single high volume, affordable solution may not be possible for post manufacture isolation of the MTP from the metallic substrate. It may be highly advantageous to achieve the resistance to eddy currents from metal substrates as part of the on-chip structures.

In some embodiments, successful elimination of eddy currents may be achieved with active or passive materials and or combinations thereof. Active materials may absorb, scatter, destroy or reflect the Eddy currents away from the chip and its signals. Filler materials such as ferrite are also known to act as active materials. Passive materials may not interact at all with the eddy currents and provide a physical separation between the substrate and the IC signals. Glass, ceramics and inorganic media are known materials providing passive separation and are compatible with IC manufacturing.

In some embodiments, the base or near base layer of IC design may be fabricated with a passive material or filled with an active material. A base layer may be formed post foundry by attaching passive or active substrate to the MTP chip.

Various methods or technologies may be utilized for the base layer of IC design, but not limited to the methods or technologies, including:

Physical build processing by vapor phase or chemical deposition. While most passivation layers are built to eliminate corrosion of the IC & components, extending the thickness of the back of the chip by deposition of a non-conducting inorganic layer acts as a physical spacer to isolate the IC and its circuitry from the metal substrate causing interference.

Physical layer build processing from liquid media with subsequent thermal or radiation curing in a field of polysilazane/polysiloxane chemistry. The two chemistries described are capable of making durable non-conducting films and structures with excellent adhesion to other inorganic surfaces. Such sol-gel systems can be applied as a liquid coating by casting, spraying, dip or spin based applications to precise films.

Attachment of active or passive monolithic layer to wafer by liquid, gel or solid media followed by thermal or radiation curing in a field of polysilazane/polysiloxane chemistry. The same sol-gel systems may be used as adhesives to bind other structures such as a glass sheet to the back of an IC wafer. In some embodiments, a passive monolithic layer may be glass or a filled glass structure.

Hybrid organic-inorganic polymeric matrices may be considered as they have greater flexibility and may be an organic route to lower temperature applications. One drawback of sol-gel films is that they may be brittle. Adding small amounts of organic materials into the inorganic sol-gel system may decrease brittleness. A material tradeoff of creating a hybrid sol-gel is that the high temperature resistance is degraded.

End use applications may be directed to metal or contain metal filled layers or particles.

The present disclosure may identify known or perceived conditions of use, range of efficacy or limitations. While high temperature service conditions are key features of a P-Chip™ MTP, metallic objects used in low or ambient temperature applications such as asset tagging are equally important. Therefore, organic-based eddy current elimination schemes may also be utilized for low to ambient temperature applications. During the manufacturing process of MTP with the enhanced signal distance, various material may be used, but not limited to inorganic films, coatings and adhesives, high temperature hybrid organic-inorganic matrices and materials, and high temperature organic insulating materials, etc.

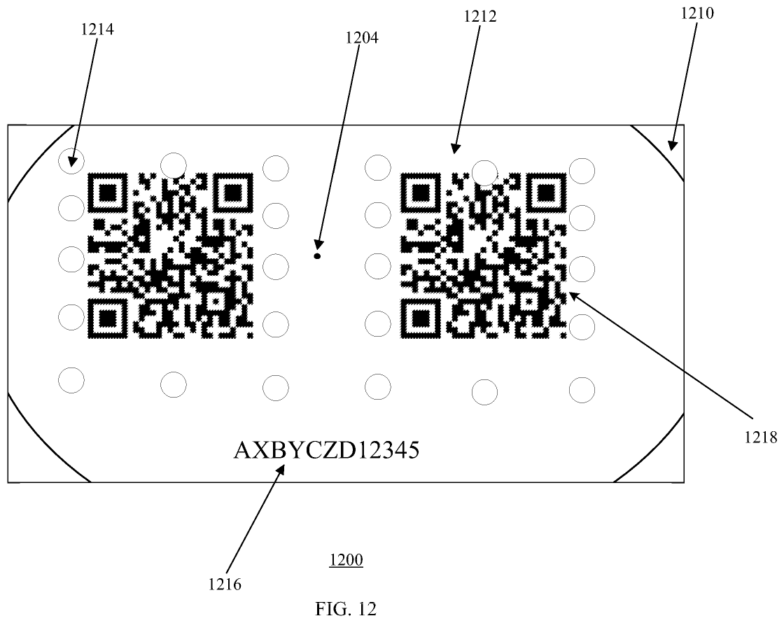

FIG. 12 shows an example tagging system 1200 for an edible matrix, according to example embodiments of this disclosure. In the shown example, the edible matrix may include cheese 1210. The edible matrix may be incorporated into a food product.

Within the tagging system 1200, an example MTP 1204 (which may be similar to MTPs 104 described throughout this disclosure) is shown. The MTP 1204 is affixed adjacent to a data matrix code (e.g., a QR code) 1218 on a label 1212 on the cheese 1210. The label 1212 may further include a plaintext code 1216. FIG. 12 also illustrates the relative size of the MTP 1204 compared to the other tagging techniques. Furthermore, the cheese 1210 is just but an example and should not be considered limiting. Any food product that can be tagged should be considered within the scope of this disclosure. Indeed, several other example food products are described herein.

Each scan can include information such as the identity of the scanned item, time of the scan, location of the scan, identity of the equipment and processing parameters and/or person performing the scan, the position of the scanned item relative to other objects scanned and information about the packaging holding the object, all of which may form a data packet. A chronological record of multiple such scans and resulting data packets can be created and stored on a computer-readable medium, and additionally be accessed and verified as necessary by authorized users. Further, such a record may be prevented from being edited, thereby avoiding any possibility for falsification. A portion of the record may be stored on the MTP 1204 itself. In some embodiments, the record may be securely stored in a blockchain.

Dairy products (e.g., cheese 1210) are amenable to tracking as one starting material (milk) gets converted to multitude of food products, by a variety of processes; and are distributed in several temperature conditions (e.g., room temperature, cold storage or frozen). Further, dairy products benefit from having such a record of the source, custody, and handling, as these products make their way to human consumption at varying timescales. For instance, milk is usually consumed in the order of days after milking, whereas the resulting cheese 1210 may be consumed weeks, months, or even years later.

The ability to individually track all these process and logistical parameters allows for a deep understanding of the chain of custody. In the event of a contamination at source (such as a batch of milk), it becomes possible to indelibly identify all the various downstream food products emanating from the contaminated batch of milk.

As an example, cheeses (e.g., cheese 1210) are a class of dairy goods for which provenance is desired for safety, brand, and market value. Cheeses may be classified as “Hard,” “Medium,” or “Soft” based on the texture or aroma, resulting from the extent of ripening (aging). The labeling for cheese may be very specific, e.g., pertaining to a particular geographical region, a particular type of dairy animal, and/or a particular type of cheesemaking. Authentication of these specific labels is desired, because there is a large incentive to the counterfeiters to affix deceptively label the sub-standard cheese.

Hard cheeses, i.e., cheese that have a ripening period over several months (e.g., Parmigiano, Grana Padano, Pecorino, Cheddar, Gruyere, Emmental, etc.) are typically amenable to an inclusion of a security element or taggant directly onto the surface of the cheese, or via a label. Such labels may be edible by humans, and at least may be approved for direct food contact. Further, colored casein labels may be used to identify and distinguish cheese. For example, a distinct color may be used to designate cheese made from milk of cattle that graze in alpine regions. For example, the shown label 1212 is made of naturally occurring protein casein and imprinted with markings, e.g., to show the data matrix code 1218 and the alphanumeric code 1216. The ink used for imprinting might be edible, for example, inks derived from vegetable sources. The label 1212 may contain information such as the manufacturer, the type of cheese, origin, batch, date of manufacture (e.g., as shown by the alphanumeric code 1216) as well as encoded logic structures such as a data matrix (e.g., QR code 1218). The advantage of using casein is that casein, being a natural milk protein, becomes subsumed into the cheese rinds (i.e., a rigid exterior of the cheese), as the cheese ripens, thereby making the casein hard to separate out from the cheese, affording security. Further, casein label is edible and may not alter the taste of cheese. In some embodiments, the cheese label 1212 may include perforations 1214.

“Soft” cheeses are typically un-ripened and made by coagulating milk proteins with an acid. Such cheeses may be made with pasteurized or unpasteurized milk. Due to their relatively high moisture content (compared to “hard” cheeses), they tend to undergo microbial fermentation until the point of consumption. Therefore, “soft” cheeses tend to have a smaller shelf life compared to “hard” cheese. Further, soft cheese typically does not contain a rigid exterior (i.e., “rind”), and therefore do not get labeled with casein tags as is in the case of hard cheeses.

Certain soft cheeses a may be made from unpasteurized milk and are often referred to as “raw milk cheeses”. Examples of such cheeses include Camembert, Brie, Roquefort etc. Such cheeses tend to have an increased risk of bacterial outbreaks of E. Coli, Listeriosis, Salmonellosis or other bacterial infections.

MTPs (such as the MTP 1204) are qualified for tagging soft cheeses. As described above, soft cheeses are typically do not possess a rigid exterior, as hard cheeses do. As a result, cheese wheels from soft cheese tend to be considerably smaller in dimension. The small surface footprint of the MTP 1204 makes it particularly favorable for tagging soft cheeses, even when a rigid exterior is absent. Further, MTP 1204 is aseptic (biologically inert) and does not interfere with the biochemical processes, such as ripening, that are active in soft cheese.

Non-dairy cheeses are becoming an increasing component of modern diet. While the non-dairy milk used in the preparation of such cheeses may come from different sources (typically tree nuts, seeds, etc.), several other additives, such as starchy flour, agar, carrageenan, and xanthan gum are added to create a flavor and texture similar diary cheese. Tracking the provenance of each of these ingredients is critical to the provenance of the resulting cheese. The MTP 1204 present on the cheese may be linked to the have provenance information of various ingredients.

The quality, texture, and taste of cheese and non-dairy cheese varies significantly with the corresponding manufacturing processes. It is therefore desirable to record multiple parameters in the process of manufacture of cheese, such as process parameters, potential sources of contamination, and chain of custody. It is impractical to record detailed information of all this directly on the block, or wheel of cheese (e.g., cheese 1210) itself.

Albeit commonly used, casein labels (e.g., label 1212) also suffer from several technical shortcomings. Casein labels may become illegible, washed out, or stained over time, due to the environmental factors and the variety of chemicals that are released during the cheese maturation process. It is also challenging to replicate the casein label, if a large block of cheese (such as a wheel) is portioned into smaller pieces, most of which will then be devoid of the security marking.

Further there is no certification or standardization of the labels, making it relatively easy for fraudulent/counterfeit labels to be used. Additionally, there is no easy manner in which the authenticity, age of the cheese, or quality of the ingredients used can be audited.

Digitization of cheese labels has been used in attempt to overcome these shortcomings. For example, RFID tags have been suggested, as described above. For example, French patent Application No. 2895213 describes the inclusion of an electronic chip and corresponding antenna coil directly in or on an organic support, such as casein, with size 20 mm-100 mm, and particularly of sizes 45-65 mm if rectangular, and with a diameter of 10 mm-50 mm if circular, and between 40-100 mm along its longest axis if ovoid. With these dimensions, the chip and the antenna occupy a significant area (e.g., >50%) of a typical cheese label (generally 20 mm-100 mm along its longest side). At this size, the cost of the RFID tag becomes prohibitive for a one-time use and must be extracted after the maturation of the cheese, to be reused for other batches, or repurposed for different uses. Reused or repurposed RFID tags have the potential to introduce contaminants to fresh batches. Extraction of used RFID tags also introduces additional costs to a cheese manufacturer and opens the possibility for introduction of errors or loss of provenance in the supply chain.

The process of maturation of cheese releases several chemicals such as acids, carbon dioxide, and water. The released chemical cause changes to the bulk properties of the cheese (often matured as “wheels”), based on the type of cheese. For instance, in cheeses such as Emmental or Swiss, the chemicals often result in formation of holes (often also referred to as “eyes”) and also lead to the commonly observed bulging of cheese wheels during maturation. These changes (e.g., bulging) may place pressure buildup at the antenna of the RFID tags, which may deform or break and adversely affect the readability of the tags.

Owing to the chemical changes during maturation, the bulk properties of the cheese and dielectric constant vary throughout the maturation process. As a result, the ability of RFID tag readers can vary significantly, with the type of cheese (which undergo varying change in physical properties and dielectric constants during maturation); and the time-point of reading during the maturation. To overcome the limitations of deformed antennas or impact of varying dielectric constants during maturation, the RFID tags are placed on a sturdy substrate (such as plastic or polypropylene support), which need to be extracted after the maturation. Embedding the RFID into such a substrate further adds more cost.

Wheels of certain cheeses such as Grimont are regularly washed with salt water during the maturation process—which essentially makes the RFID tags unreadable till they are dry. The washing also induces corrosion that later impacts reading from the device or even disables the RFID tags unless they are preserved in sealed encasement, adding more costs.

MTPs (e.g., MTP 1204) offer significant technical advantages compared to RFIDs as taggants for cheese. First, their small size (e.g., approx. 500 microns×500 microns×100 microns, just as an example and not to be considered limiting) makes it possible for them to be easily included in commonly used casein tags without any noticeable change to the appearance or dimensions, as shown in FIG. 12. This enables the MTP 1204 included casein labels to be introduced in the cheese making process without any changes to current practices. As the cheese matures, the MTP-included casein label 1212 becomes part of the rinds and does not distort the cheese manufacturing process materially.

Second, as MTPs either partially or completely enclosed in glass (or glasslike material or polymers, and/or any other type of passivation layer), they are inert to the chemicals evolved in cheese making process and the subsequent handling steps. Further, because the interrogation of MTPs occurs with light, the interrogation process is not influenced by environmental factors such as humidity or temperature. Consequently, the readability of MTPs remains unchanged throughout the cheese maturation process.

Owing to the small size and rugged build, the MTPs included in the casein tags are not influenced by the change of pressure or bulk properties of the cheese. As the cheese matures, the MTP-included casein label gets subsumed into the rinds and can be used to track the cheese wheel throughout the remaining steps of the cheese manufacturing process.

The small size of MTPs renders them useful to mass production and allows them to be available at a much lower cost compared other silicon based taggants such as RFIDs. Therefore, it may be economic to add multiple MTPs-containing casein labels to wheel or cheese. This assists to limit the need to move or re-orient the cheese wheel significantly (such as when multiple cheese wheels are stacked a top one another) to enable a successful read using an appropriate reader, no matter the orientation or location of the reader vis-à-vis the cheese wheel.

It is conceivable that cheese wheel containing MTP-included casein labels may be rolled in the process of displacing them between two locations. The MTP-included casein label may be read by a stationary reader. When multiple MTP-included casein labels are present, the wheels may be read while in motion, using a stationary reader.

The MTPs may be embedded in (or otherwise be a part of) the packaging of the food material. In the example of the food material being cheese, the MTPs may be embedded in the wax of the cheese. In other examples, the MTPs may be part of a polymer film covering the food material. In some examples of the food material being a liquid (e.g., alcohol), the MTPs may be a part of the bottle holding the food material. It is understood that the introduction of the MTPs to the packaging through any kind of technology, including but not limited to printing (e.g., 2D printing, 3D printing), embedding, molding, and/or any other type of technology, is feasible.

MTPs can often be read through packaging materials used in cheese (e.g., cheese 1210). Common types of packaging used for cheese include polymer wraps, either in the form of coating or clear plastic wraps. Clear plastic wraps (such as SARAN® wraps) cling to the surface of the food product to provide protection against spoilage. Paraffin-based wax is commonly used to embellish whole wheels of hard cheese or smaller sections. The wax may be pigmented to provide a color to the wax coating. Red color is commonly used for this purpose. Cubes or smaller chunks may be placed in clear plastic containers.

The ability of MTPs to be read through such packaging material makes the MTPs particularly useful for applications in food distribution chain, and a significant advantage compared to printed labels.

Separate MTPs (“child” MTPs) can be placed on sections of cheese resulting from a larger tagged (“parent MTP’) cheese wheel. Identification data from the “parent” MTP” placed on the larger cheese wheel can be passed on or associated with the child MTP on the smaller sections. Additionally, MTPs can be placed within internal structures of the cheese.

The usage of the MTPs in cheese is just an example and should not be considered limiting. As described throughout this disclosure, MTPs can be used in any kind of edible matrix making a food product.

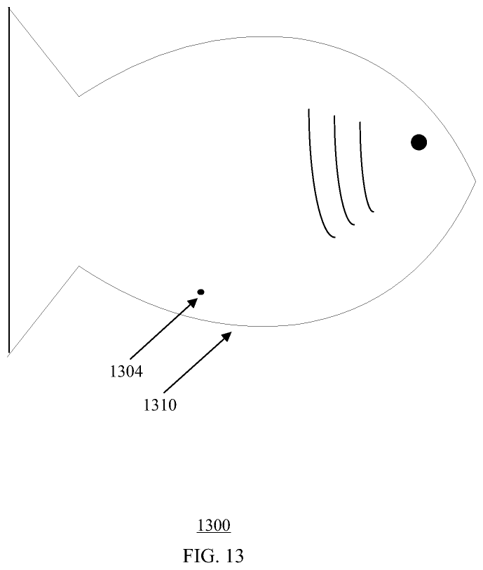

For example, FIG. 13 shows an example taggant system 1300, according to example embodiments of this disclosure. As shown, an MTP 1304 (e.g., similar to MTP 104 described throughout this disclosure) is provided on a seafood item 1310 such as a fish. The MTP 1304 may be attached to the seafood item at the time of the catch, during processing, during transportation, and/or any step of the distribution chain. As the MTP 1304 is food grade, the MTP 1304 may not have to removed prior to eating or cooking. Additionally, as the passivation layer of the MTP 1304 provides a biological and chemical barrier, the various changes the seafood 1310 undergoes throughout the extraction, distribution, and consumption cycle does not affect the MTP 1304.

MTPs are also amenable to tracking food products in bulk such as grains, beans, or nuts. Grains such as wheat, rice, corn, oats etc. form the staple of the majority of the world population. Nuts, such as cashews, peanuts, pistachios, hazelnuts, Brazil nuts, pine nuts, beechnuts, butternuts, almonds, etc. are consumed globally. Beans such as coffee, cocoa etc. are important cash crops. These grains, beans, and/or nuts are cultivated, harvested, processed, packaged, and shipped to consumers. Each of the steps following harvesting may occur at different facilities, with multiple entities getting involved.

To ascertain the provenance of such food products, MTPs can be introduced into the bulk of such material at the time of harvesting or any subsequent step during the processing. The MTPs introduced may be removed at any time during the subsequent steps or prior to consumption of the food product. The MTP may be left in the bulk during the processing steps including but not limited to washing, drying, roasting, grinding, or packaging of the food products.

The chemical and thermal resistance characteristics of MTPs, combined with their ruggedness and biological inertness makes them uniquely adaptable to tagging food (e.g., tagging bulk food products). Other taggants such as RFIDs, NFCs would be disfigured upon heating, or lose readability in presence of moisture (such as during a washing step).

The MTPs can be used to store information such as the origin of the food product, date of harvest, steps involved in the processing, process details such as times, duration, chemicals used, labor involved etc.

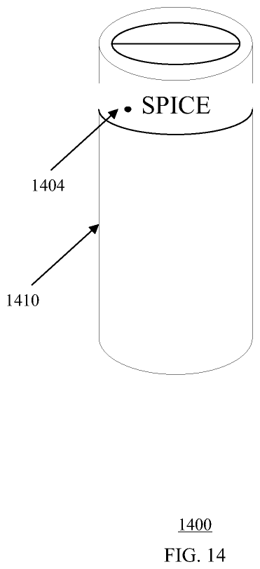

For example, FIG. 14 shows an example taggant system 1400, according to example embodiments of this disclosure. As shown, the taggant system 1400 comprises an MTP 1404 (which may be similar to MTP 104 described throughout this disclosure) on a spice container 1410. Although the MTP 1404 is shown on the surface of the spice container 1410, the MTP 1404 may be placed anywhere within the spice container 1410, provided the MTP 1404 is amenable to reading using an MTP reader. The spice container 1410 may contain the spice in a powder form.

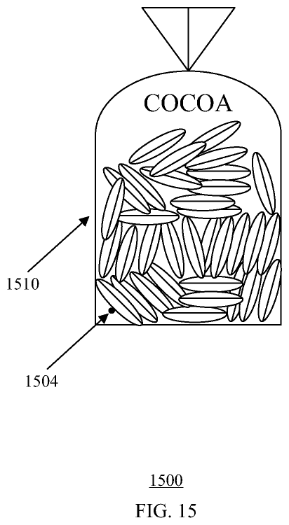

As another example, FIG. 15 shows an example taggant system 1500, according to example embodiments of this disclosure. As shown, the taggant system 1500 comprises a MTP 1504 (which may be similar to MTP 104 described throughout this disclosure) on a bag 1510 containing cocoa beans. As described above, the MTP 1504 may be used to track the provenance of the cocoa beans from harvesting to sale to the end customer. As MTP 1504 is food grade, its ingestion will not adversely affect the consumer. As shown, the MTP 1504 may be placed at any internal location within the bulk of the cocoa beans in the bag 1510.

As used herein, an internal location should be understood to include any internal location within an edible matrix. For example, the internal location may be within a bulk of grains, beans, spices, cereals, nuts, or the like. In another example, the internal location may be within a bulk of cheese. Therefore, internal locations within any kind of edible matrix should be considered within the scope of this disclosure.

To aid their removal, the MTPs may be embedded on a larger support. Such support may be made from a rigid substance (or rigid support), such as a wood, polymer, metal, carbon fiber, or any type of suitable biologically inert material. The MTPs, with or without the support may be removed from the bulk by filtering, sieving, washing, and/or physical removal. The rigid substrate may be placed at any location vis-à-vis the edible matrix. For example, rigid substrate may be a pin, a screw, and/or any type of elongated tube that may be used to affix a label to the edible matrix.

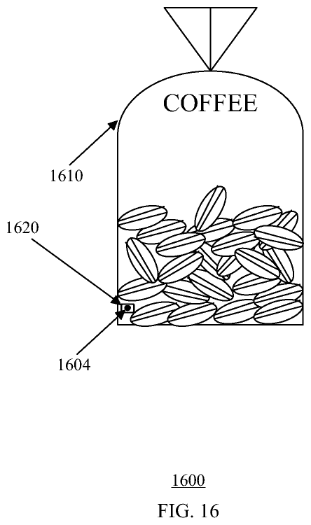

For example, FIG. 16 shows an example taggant system 1600, according to example embodiments of this disclosure. As shown, the taggant system 1600 comprises a MTP 1604 (which may be similar to MTP 104 described throughout this disclosure) on a bag 1610 containing coffee beans. As shown, the MTP 1604 may be placed at any internal location within the bulk of the coffee beans in the bag 1610. As also shown, the MTP 1604 may be embedded into a surface of a support structure 1620.

In one embodiment, the support structure 1620 may comprises a rectangular 0.5 inch×0.5 inch polypropylene puck. Such puck may be placed into a bag 1610 of coffee beans and scanned by a reader. The scan would time stamp the reading, record its geographical location, and create a record in the database. In subsequent steps, the coffee beans may be washed, dried, mixed with other ingredients (such as flavors), and roasted. The puck bearing the MTP 1604 may be left in the bulk of the coffee beans through all these steps, or the puck may be removed or added back as appropriate. The puck may be scanned intermittently after each of these process steps and the details of the steps involved may be recorded. The roasted coffee beans, along with the puck, may be packaged and sold. The consumer purchasing the coffee beans may choose to verify the origin and process details of the batch of coffee, by scanning the puck with a MTP reader. The consumer may subsequently choose to grind the coffee beans and prepare coffee by passing hot water through the ground coffee beans, placed in a coffee filter. The puck may remain with the ground coffee on filter and may then be discarded. Although the support structure 1620 is described for the MTP 1604 within a coffee bag 1610, embodiments with the support structure 1620 is applicable to any type of edible matrix. Additionally, the support structure 1620 can be used at any location vis-à-vis the edible matrix (e.g., coffee). For instance, the support structure 1620 may include a pin, a screw, and/or any kind of elongated tube that may be used to affix a label to the coffee bag 1610.

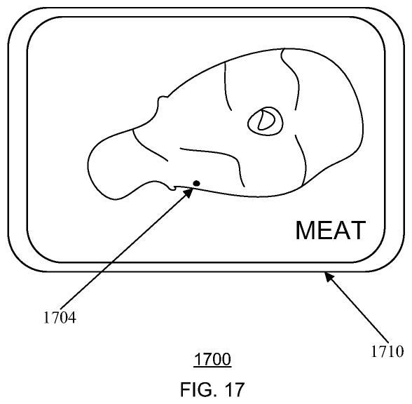

FIG. 17 shows an example taggant system 1700, according to example embodiments of this disclosure. As shown, the taggant system 1700 comprises an MTP 1704 (which may be similar to MTP 104 described throughout this disclosure) attached to a packaging 1710 for meat. In some embodiments, the MTP 1704 may be attached on the meat itself. As the MTP 1704 is food grade, consuming the MTP 1704 with the meat does not adversely affect the consumer.

Although the example taggant systems 1200, 1300, 1400, 1500, 1600, 1700 are used to illustrate different aspects of the several embodiments; all features of each taggant system are applicable to other taggant systems as well.

The biological inertness of MTPs (thereby making the MTPs food grade) may be based on their structures. MTPs are generally made of monolithic integrated circuits. Compared to conventional RFID tags with multiple separated components, the monolithic integrated circuits may be tightly coupled and kept within a passivation layer (e.g., glass casing, polymer casing, etc.). In other words, the MTPs may not provide a surface for a biochemical reaction, if ingested by humans or animals. That is, the MTPs may safely pass through the alimentary canal without causing any harm thereto. This biological inertness therefore makes the MTPs edible. The edibility allows the MTPs to be embedded within any layer of a food matrix. For example, the MTPs may not necessarily have to be on the surface of a food product, they can be within any depth of the food product—provided they can be read using a MTP reader. For example, the MTPs may be placed inside a milk container, where they can be directly in the milk that moves around during its transport.

The monolithic structure along with the passivation layer allows the MTPs be robust in any type of chemical and biochemical environment. For example, the MTPs can be safely used throughout food production, e.g., in the context of cheese making, same set of MTPs can be used through milk collection, coagulation, hardening, salt bathing, maturation, etc. The same set of MTPs can be used when the cheese comes to market. Therefore, the set of MTPs can provide a complete provenance of the cheese. The monolithic structure with the passivation layer is also further robust against cracking and/or any other type of structural damage.

In some embodiments, the information stored in the MTPs may be encrypted, and the MTP reader may have to decrypt the encrypted data to access the information.

In some embodiments, MTPs may be embedded into both a food material and also its packaging. For instance, a first MTP may be embedded within the food material and a second MTP may be embedded in the packaging for the food material. The first MTP and the second MTP may form a matching pair, which may be indexed to a back-end database.

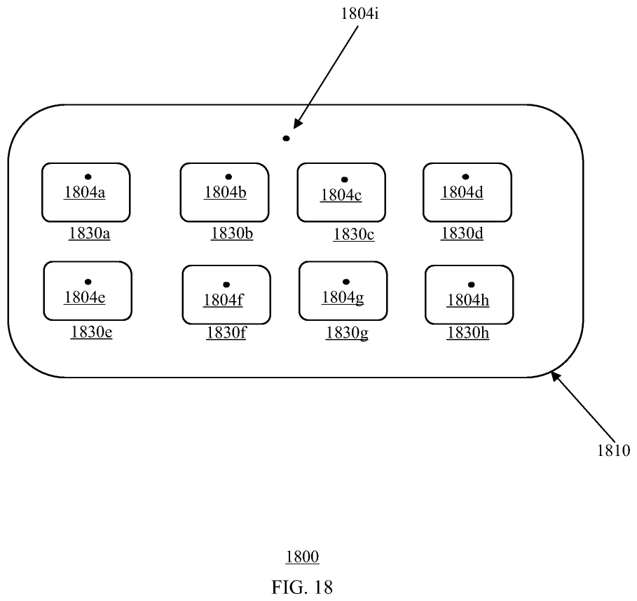

In some embodiments, the MTPs can be used in hierarchical arrangements. FIG. 18 shows an example taggant system 1800, according to example embodiments of this disclosure. As shown, a food container 1810 may include individual food items 1830a-1830h. The individual food items 1830a-1830h may be smaller containers, for example, the food container 1810 may be larger bag containing individual packets 1830a-1830h of trail mixes. As another example, the individual food items 1830a-1830h may be slices/portions of the food item. For example, the individual food items 1830a-1830h may be slices of cheese within a larger cheese block 1810. Therefore, any combination of the smaller food items combined in a larger package should be considered within the scope of this disclosure. The hierarchical arrangement of the MTPs may include an MTP 1804i on the food container 1810 and other MTPs 1804a-1804h corresponding to individual food items 1830a-1830h. That is, MTPs 1804a-1804h can be placed at different internal locations within the bulk comprising the individual food items 1830a-1830h. The hierarchical arrangement of the MTPs 1804a-1804i allows for the individual food items 1830a-1830h to be tracked individually, in relation to each other, and/or in relation to the food container 1810.

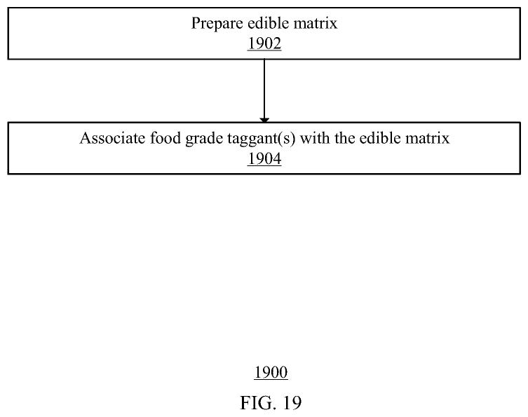

FIG. 19 shows a flow diagram of an example method 1900 of tagging an edible matrix, according to example embodiments of this disclosure. It should be understood that the steps of the method 1900 are merely examples and should not be considered limiting. Methods with additional, alternative, or fewer number of steps should be considered within the scope of this disclosure.

At step 1902, an edible matrix may be prepared. As described throughout this disclosure, the edible matrix may include at least one of dairy cheese, non-dairy cheese, coffee beans, cocoa beans, grains, nuts, meat, seafood, spices, and/or any other type of food items. The preparation of the edible matrix should be understood to include any type of food production and/or distribution process including but not limited to, harvesting, de-husting, washing, grinding, roasting, packaging, fermenting, coagulating, ripening, hardening, cooking, and/or any other type processes.

At step 1904, food grade taggant(s) may be associated with the edible matrix. A food grade taggant may include, for example, a light triggered microtransponder comprising a monolithic integrated circuit, wherein the monolithic integrated circuit is enclosed within a passivation layer that forms a barrier with the edible matrix. In some embodiments, the monolithic circuit may have maximum dimensions of 2 mm length, 2 mm width, and 0.2 mm thickness.

As used herein, an association of the food grade taggant with the edible matrix (or any other component) should be understood to include any one of a physical attachment, embedding, co-location, side-by-side placement, placement in proximity, placement within a same box or container, a digital association, and/or the like. Similarly, an association of an MTP with the edible matrix (or any other component) should be understood to include any one of a physical attachment, embedding, co-location, side-by-side placement, placement in proximity, placement within a same box or container, a digital association, and/or the like. Therefore, an association should be understood as a broader embodiment of a physical or non-physical functional combination of two components.

In some embodiments, a plurality of food grade taggants may be associated the edible matrix. Each of the food grade taggant may include a light triggered microtransponder comprising a monolithic integrated circuit, wherein the monolithic integrated circuit is enclosed within a passivation layer that forms a barrier with the edible matrix. The plurality of food grade taggants may form a taggant system (for example, as described in reference to FIG. 18), wherein any combination of the food grade taggants may be used to determine the provenance of the food.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted as a means plus function limitation (e.g., under 35 U.S.C. 112(f) in the United States). Claims that do not expressly include the phrase “means for” or “step for” are not to be interpreted as means plus function limitations (e.g., under 35 U.S.C. 112(f)).

1-106. (canceled)

107. A food grade taggant for an edible matrix, comprising:
a light triggered microtransponder comprising a circuit; and
the circuit enclosed within a passivation layer that forms a barrier with the edible matrix.

108. The food grade taggant of claim 107, wherein the circuit has maximum dimensions of 2 mm length, 2 mm width, and 0.2 mm thickness.

109. The food grade taggant of claim 107, wherein the light triggered microtransponder is configured to transmit an electromagnetic data beam.

110. The food grade taggant of claim 109, wherein the electromagnetic data beam is at least one of an emission from a light emitting diode (LED), an infrared light beam emission, a near-infrared light beam emission, and a radio wave.

111. The food grade taggant of claim 107, wherein the light triggered microtransponder is configured to be associated with at least one of a surface of the edible matrix, a label, a rigid support, and an internal location of the edible matrix.

112. The food grade taggant of claim 107, wherein the edible matrix comprises at least one of fruit, vegetable, milk, cheese, non-dairy cheese, egg, meat, cured meat, lab-grown food, seafood, coffee beans, cocoa beans, grains, and nuts.

113. The food grade taggant of claim 107, wherein the light triggered microtransponder is configured to be associated with at least one of a radio frequency identification (RFID) tag on a surface of the edible matrix, an RFID tag on the label, and a printed code on the label.

114. The food grade taggant of claim 107, wherein the light triggered microtransponder is configured to be associated with the edible matrix during at least one of processing, storage, manufacturing, and distribution of the edible matrix.

115. The food grade taggant of claim 107, wherein the edible matrix is in at least one of powder, solid, paste, liquid, and viscous liquid form.

116. The food grade taggant of claim 107, wherein the light triggered microtransponder is configured to indicate provenance information of the edible matrix.

117. The food grade taggant of claim 107, wherein the light triggered microtransponder is configured to interact with a reader by performing at least one of being triggered by the reader and providing a provenance information of the edible matrix when triggered by the reader.

118. The food grade taggant of claim 107, wherein the food grade taggant is printed using 3D printing.

119. The food grade taggant of claim 107, wherein the passivation layer is formed of at least one of a glass, a polymer material, and an inorganic medium.

120. The food grade taggant of claim 107, wherein the light triggered microtransponder is configured to be edible.

121. The food grade taggant of claim 107, further comprising:
a clock recovery circuit comprising a photoconductor, the photoconductor comprising a source terminal, and a drain terminal coupled to a power source, the photoconductor having a resistance configured to vary as a function of received radiation intensity, the clock recovery circuit configured to generate a recovered clock.

122. A system of tagging an edible matrix, the system comprising a plurality of the food grade taggants of claim 107.

123. A method comprising:
associating an edible matrix with a light triggered microtransponder comprising a circuit, the circuit being enclosed within a passivation layer that forms a barrier with the edible matrix.

124. The method of claim 123, further comprising at least one of:
storing, by the light triggered microtransponder, provenance information of the edible matrix;
triggering, by a reader, the light triggered microtransponder; and
providing, by the light triggered microtransponder, the provenance information of the edible matrix when triggered by the reader.

125. The method of claim 123, further comprising:
transmitting, by the light triggered microtransponder, an electromagnetic data beam.

126. The method of claim 125, wherein the electromagnetic data beam is at least one of an emission from a light emitting diode (LED), a laser, an infrared light beam emission, a near-infrared light beam emission, and a radio wave.

127. The method of claim 123, wherein the associating is performed during at least one of processing, storage, manufacturing, and distribution of the edible matrix.

128. The method of claim 123, further comprising indicating, by the light triggered microtransponder, provenance information of the edible matrix.

129. The method of claim 123, further comprising interacting, by the light triggered microtransponder, with a reader by performing at least one of being triggered by the reader and providing a provenance information of the edible matrix when triggered by the reader.

130. The method of claim 123, further comprising forming the food grade taggant using 3D printing.

131. The method of claim 123, further comprising forming the passivation layer of at least one of a glass, a polymer material, and an inorganic medium.
